(19) United States
(12) Patent Application Publication
(10) Pub. No.: US 2012/0242240 A1
(43) Pub. Date: Sep. 27, 2012

(54) BALLAST EFFICIENCY IMPROVEMENT FOR FLUORESCENT LAMPS

(76) Inventors: Cornelis Jozef Petrus Maria Rooijackers, Waalre (NL); Ewold Huibertus Van Geffen, Weert (NL)

(21) Appl. No.: 13/430,378

(22) Filed: Mar. 26, 2012

Related U.S. Application Data
(60) Provisional application No. 61/467,519, filed on Mar. 25, 2011.

(51) Int. Cl. H05B 41/36

(52) U.S. Cl. 315/206

(57) ABSTRACT

A half bridge resonant topology ballast for use with a fluorescent lamp includes a resonant tank and a resonance inductor having a secondary winding. The secondary winding is arranged for series connection to the fluorescent lamp, and the secondary winding provides a voltage that reduces the resonant tank voltage.

This patent document claims benefit under 35 U.S.C. §119 to U.S. provisional Patent Application Ser. No. 61/467,519, entitled “BALLAST EFFICIENCY IMPORVEMENT FOR COMPACT FLOURESCENT LAMPS” and filed on Mar. 25, 2011, which is fully incorporated herein by reference.

One or more embodiments relate to fluorescent lamp ballasts, and, more particularly, to ballasts for use in compact fluorescent lamps (CFLs).

The efficiency of a half bridge resonant fluorescent lamp ballast is a very important parameter. This efficiency can be increased by using more low Ohmic switches in the half bridge and thicker wire in the inductor. However, providing more low Ohmic switches increases the cost of the ballast. Using thicker wire in the inductor means the inductor size will increase, which can both increase costs and have mechanical consequences if the ballast is meant to be used for a retrofit compact fluorescent lamp (the lamp shape will dictate the available space).

The reactive current causes losses in ballast circuitry. For example, ballasts having a half-bridge resonant configuration typically suffer losses in switching field effect transistors (FETs) and inductors. One or more embodiments help to reduce these losses, and thereby increase the efficiency of the ballast. A resonant tank circuit is implemented using a primary winding of a transformer as an inductor in an LC circuit. A secondary winding of the transformer is placed in a counter-phase configuration in series with a fluorescent lamp driven by the ballast. Addition of the counter-phase secondary winding may provide higher lamp efficiency for both internal and external FETs. The embodiments may also reduce hardware requirements, resulting in a ballast that is less expensive to produce. For instance, with regard to the use of external FETs, this invention can provide higher efficiency and/or cheaper FETs.

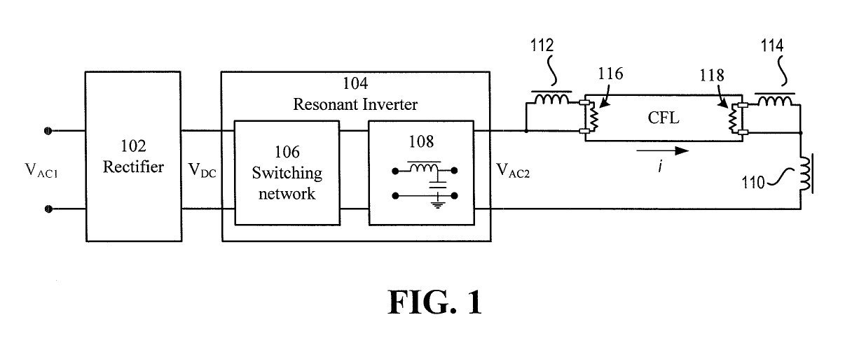

FIG. 1. shows a block diagram of a lamp ballast circuit configured in accordance with one or more embodiments;

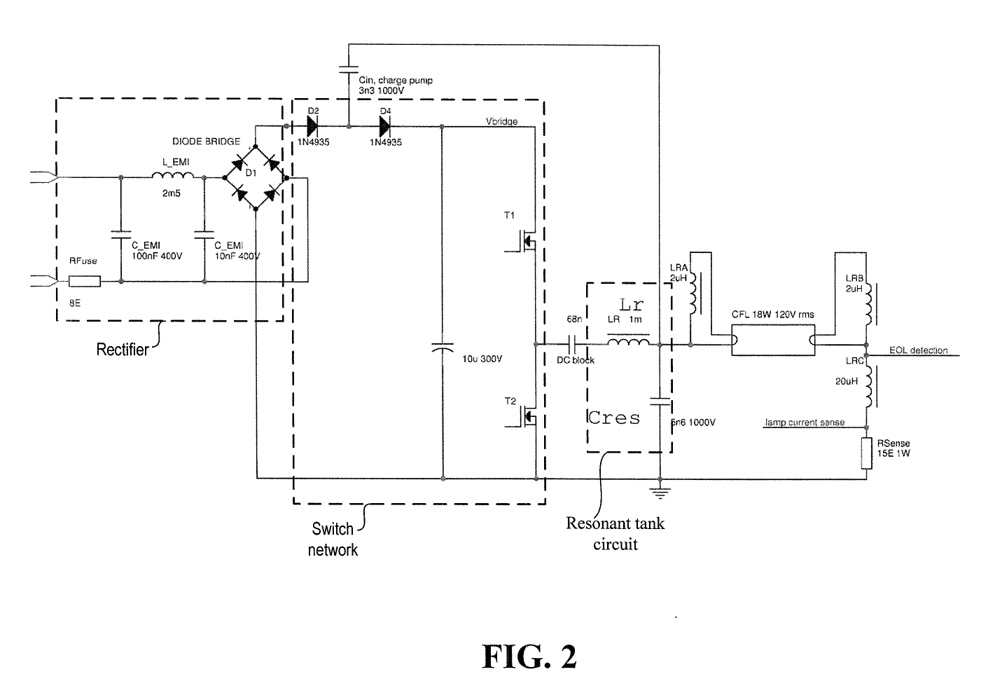

FIG. 2 shows a circuit diagram of a lamp ballast configured in accordance with one or more embodiments;

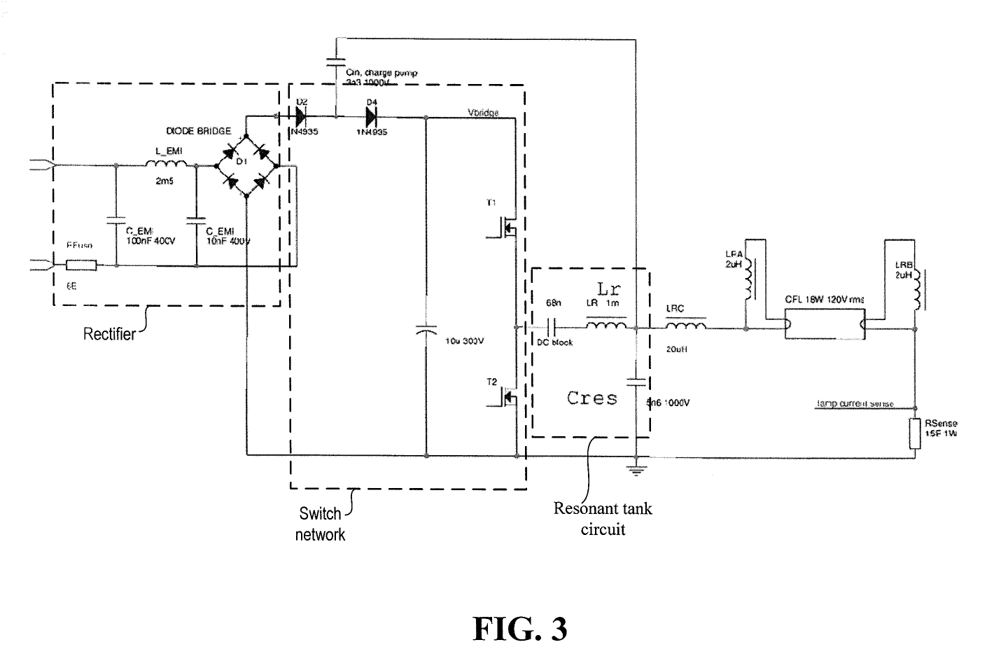

FIG. 3 shows a circuit diagram of a lamp ballast configured in accordance with one or more embodiments; and

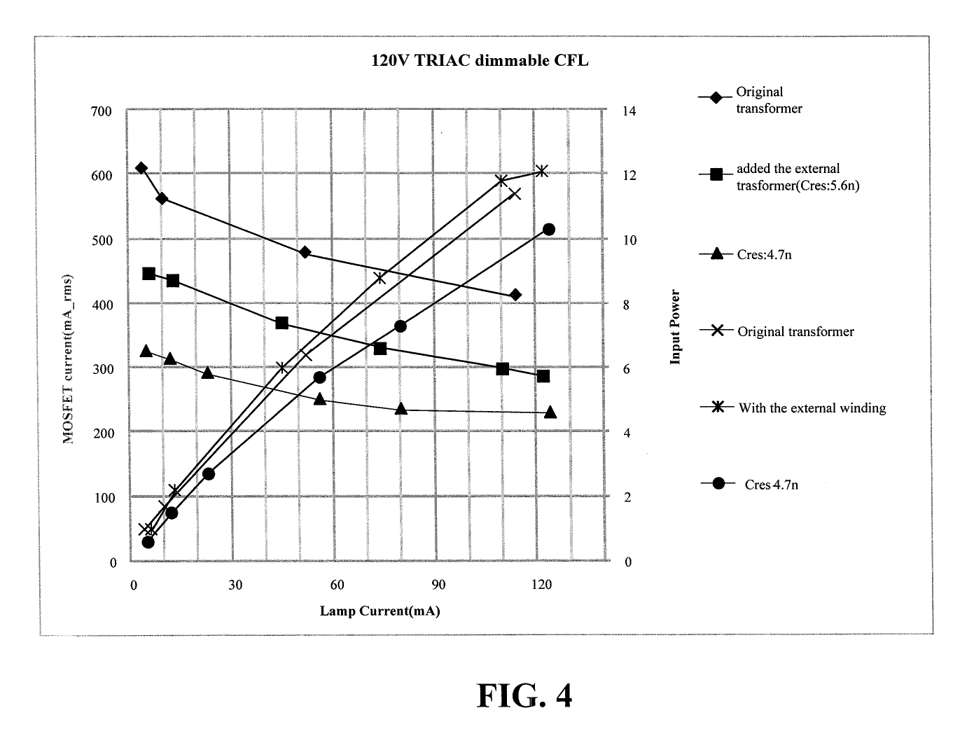

FIG. 4 shows a two-in-one graph comparing (1) MOSFET current through the FETs and inductor L1 with the lamp current, and (2) input power to the ballast with the lamp current for a 120V triac dimmable CFL.

One or more embodiments are directed toward a ballast of the type usable with a dimmable or non-dimmable fluorescent lamp, compact or otherwise.

As described above, electronic ballasts typically have large reactive currents that cause losses in the switches (FETs/transistors) and inductor. This can happen because, in the case of a low bus voltage (for instance, rectified 110V, 115V or 120V mains, with or without dimmer) and high lamp voltage, the resonant tank may require a low inductor value and high capacitor value. One or more embodiments provide methods and circuits for providing current to a fluorescent lamp that reduce the voltage swing needed on the resonant tank and, thus, reduces the reactive current causing the losses.

In one embodiment, a ballast for a fluorescent light, is implemented to use a primary winding of a transformer as an inductor in a resonant tank circuit. A secondary winding of the transformer is placed in a counter-phase configuration in series with a fluorescent lamp driven by the ballast. Voltage induced across the counter-phase secondary winding, by the primary winding, effectively reduces voltage of the resonant tank circuit.

In some embodiments, a compact fluorescent lamp is provided having a ballast configured with the counter-phase secondary winding. For example, in one embodiment, a compact fluorescent lamp includes a ballast having a first circuit configured to convert an AC current having a first frequency to a DC current and a second circuit configured to convert the DC current to an AC current having a second frequency that may be used to drive a fluorescent lamp. The second circuit includes a capacitor and a primary winding of a transformer connected in a resonant tank configuration with first and second output nodes. The fluorescent lamp is connected in series with a counter-phase secondary winding of the transformer between the first and second output nodes. In various implementations, the ballast may be configured differently to provide either a dimmable or a non-dimmable compact fluorescent lamp.

The placement of the counter-phase secondary winding may be different for different embodiments. In some embodiments, the counter-phase secondary winding may be placed in series with the lamp, between the lamp and the primary winding of the transformer. In some other embodiments, the counter-phase secondary winding may be placed on the other side of the lamp, in series between the lamp and a ground voltage. In some embodiments, the counter-phase secondary winding may be configured to perform other functions as well. For example, in one embodiment, the counter-phase secondary winding may be used for end-of-life detection of the fluorescent lamp.

FIG. 1. shows a block diagram of a lamp ballast circuit configured in accordance with various embodiments. The lamp ballast circuit includes a rectifier circuit 102 configured to convert a first AC voltage (V_{AC1}), referred to as a mains voltage, to a DC voltage (V_{DC}). A resonant inverter circuit 104 is configured to convert the V_{DC} to a second AC voltage (V_{AC2}). The resonant inverter 104 includes a switching network 106 and a resonant tank circuit 108 having a resonant inductor and resonant capacitor in an LC arrangement. The switching network charges the resonant tank circuit 108 as needed to cause the LC circuit to oscillate at a frequency that is greater than the a frequency of V_{AC1} to generate a second AC voltage V_{AC2} that may be used to drive a fluorescent lamp, e.g., compact fluorescent lamp (CFL). The increased frequency of V_{AC2} helps to reduce the observable flicker of the fluorescent lamp.

The inductor of the resonant tank circuit 108 is implemented by a primary winding of a transformer. In some embodiments, two secondary windings (112 and 114) of the transformer are connected in series to burner terminals of the lamp. Currents induced in the inductors 112 and 114 preheat the bulb filaments 116 and 118 and keep them at the desired temperature during deep dimming operation.

As described above, for many applications, large input currents of the mains voltage can cause large voltage swings in the resonant tank circuit 108. To reduce the voltage swing of the resonant tank circuit 108, and thereby reduce losses in the inductor, a counter-phase secondary winding 110 of the transformer is connected in series with the CFL. The counter-phase secondary winding is placed in a direction such that its voltage is in counter-phase with the lamp voltage. In other words, with respect to a current i (passing through the primary winding, lamp, and secondary winding), the voltage induced in the primary winding has a polarity that is opposite the polarity of the voltage induced in the secondary winding. The orientation of the counter-phase secondary winding 110 effectively reduces the voltage over a resonance capacitor (C_{Res}) of the resonant tank circuit 108, and even allows the value of C_{Res} to be reduced while still maintaining the same lamp power. More specifically, voltage induced across the counter-phase secondary by the primary winding reduces a voltage between output terminals of the resonant tank circuit 108. In this manner, reactive current and reactive losses are reduced. The reactive current can be represented as:

Reactive current=(f*C_{Res} 2*π*V)/C_{Res},

where f is the frequency of the AC voltage generated used to drive the florescent lamp, C_{Res} is the capacitance of resonant capacitor of the resonant tank circuit, and V is the resonant voltage of the resonant tank circuit. It is recognized that if this voltage across C_{Res} is reduced, the reactive current will decrease. As a result of the decrease in the reactive current, losses in the FETs of the switching network 106 and inductor of the resonant tank 108 will likewise be reduced.

FIG. 2 shows a circuit diagram that may be used to implement the ballast in FIG. 1, in accordance with one or more embodiments. The circuit depicted in FIG. 2 employs a triac dimmable ballast with Cin being the charge pump. Similar to FIG. 1, the ballast shown in FIG. 2 includes a rectifier circuit to convert an input AC voltage to a DC voltage and a resonant inverter circuit (switch network and resonant tank) to convert the DC voltage to a second AC voltage.

The resonant tank circuit includes a capacitor (C_{Res}) connected to an inductor (L_{R}) in a LC arrangement. As described with reference to FIG. 1, the inductor L_{R} of the resonant tank has two secondary windings L_{RA} and L_{RB} to preheat the bulb filaments (and keep them at the desired temperature during deep dimming operation) and a counter-phase secondary winding (L_{RC}) to reduce losses in inductor L_{R} and FETs of the switch network. In some embodiments, a third winding may be connected in series with an sense resistor (R_{Sense}) to additionally provide end-of-life (EOL) detection as shown in FIG. 2.

It is recognized that the counter-phase secondary winding may be located at various locations in series with the CFL. For instance, FIG. 3 depicts an alternative circuit configuration in accordance with one or more embodiments. To the extent this embodiment resembles the embodiment of FIG. 2, reference is made to the foregoing explanation of FIG. 2. In this embodiment, the counter-phase secondary inductor L_{RC} has been placed between inductor L_{R} and the lamp terminal in the circuit. This placement should achieve comparable performance with the embodiment depicted in FIG. 2.

However, one difference resulting from the placement shown in FIG. 3, is that the secondary winding L_{RC} is not arranged for end-of-life detection.

FIG. 4 illustrates power efficiency of some various ballast configurations. The diamond-shaped data points show current through the FETs of the switching network and inductor (transformer) L_{R} for an arrangement without a secondary counter-phase winding discussed above. In this arrangement, C_{Res} capacitor has a capacity of 506 nF. The FET current is 400 mA at a nominal full power of 100V rms at nominal power at the burners and 120V mains. “X” datapoints show power vs. lamp current for this configuration. The square data points illustrate as second configuration in which a secondary counter-phase winding is added as exemplified in FIGS. 1-3. By adding the secondary winding in series with the burner in the second configuration (square datapoints), current through the FETs and primary inductor L_{R} is reduced to 300 mA. Asterisk data points power vs. lamp current for the second configuration. As a secondary effect of the secondary counter-phase winding, the size of the resonant capacitance C_{Res} may be reduced from 5n6 to 4n7 in a third configuration while still achieving the same lamp power. This third configuration, indicated by the triangle datapoints, results in another reduction of about 80 mA rms in the FET (and inductor) current. Power vs. lamp current for the third configuration is illustrated by circle datapoints. As can be seen in FIG. 4, the losses in the FET and inductor are quadratic with this current, known to be I*I*R. (where R is the resistance of the FETs added to the resistance of the inductor). The unexpected result of second and third configurations is a reduction in losses of about 2-3 W for a 12 W lamp. Further, when deep-dimming the lamp, the losses are significantly less than those for conventional designs.

Furthermore, it should be understood that the winding ratio of the primary winding and the counter-phase secondary winding (e.g. L_{R}·L_{RC} in FIGS. 2 and 3) may be determined based on a number of factors including, e.g., optimizing the IFET current, fitting on the coil, the lamp's voltage and power, and having a sufficient voltage swing on the resonant tank for the charge pump to have a good hold current. The winding ratio may, for example, be determined mathematically.

In one implementation, the winding ratio of the primary winding and the counter-phase secondary winding may be adjusted such that counter-phase secondary winding has a voltage of about 20-40V AC that is put in series with the burner. However, it should be kept in mind that too high a voltage would cause too much counter field in the inductor and so would require too many secondary windings, as that would increase the inductor's size. By way of non-limiting example, it is contemplated that 15 secondary winding on 170 primary windings could be employed to make a 1 mH inductor having the results shown in FIG. 3.

Most burners in the 15-23 W range will have an operating voltage of about 100-130V full power (+60V dimmed to 5% lamp current as the burner voltage increases when dimmed). The resonant tank is driven by a square wave of 170V (not dimmed, rectified 120V mains). The first harmonic of this is 76V (170*SQRT(2)πI). Applications requiring higher voltages may require additional voltage swing in the resonant tank. Depending on the burner, having 20-30V on the counter-phase secondary winding may be particularly suited for many applications.

Various exemplary embodiments are described in reference to specific illustrative examples. The illustrative examples are selected to assist a person of ordinary skill in the art to form a clear understanding of, and to practice the various embodiments. However, the scope of systems, structures and devices that may be constructed to have one or more of the embodiments, and the scope of methods that may be implemented according to one or more of the embodiments, are in no way confined to the specific illustrative examples that have been presented. On the contrary, as will be readily recognized by persons of ordinary skill in the relevant arts based on this description, many other configurations, arrangements, and methods according to the various embodiments may be implemented.

While examples and embodiments are primarily described with reference to a triac dimmable ballast for compact fluorescent lamps, it is understood that some embodiments may be employed with ballasts for either dimmable or non-dimmable compact fluorescent lamps. Similarly, although examples and embodiments are primarily described with respect to fluorescent ballast driven by 120V mains current, it is recognized that embodiments may be configured to use other voltages as mains currents including, e.g., 110V and 115V mains current.

The electrical values of various circuits and components discussed above are provided only by way of example and not limitation, unless either explicitly or implicitly indicated otherwise. Likewise, the drawings described are only schematic and are non-limiting. In the drawings, for illustrative purposes, the size of various elements may be exaggerated and not drawn to a particular scale. It is intended that embodiments encompasses inconsequential variations in the relevant tolerances and properties of components and modes of operation thereof. Imperfect practice of the embodiments is contemplated.

To the extent positional designations such as top, bottom, upper, lower have been used in describing various embodiments, it will be appreciated that those designations are given with reference to the corresponding drawings, and that if the orientation of the device changes during manufacturing or operation, other positional relationships may apply instead. As described above, those positional relationships are described for clarity, not limitation.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

1-20. (canceled)

21. A fluorescent lamp ballast apparatus having a pair of electrodes for connecting to and energizing a fluorescent lamp, the apparatus comprising:
a transformer having a primary winding and a secondary winding;
a resonant tank circuit configured and arranged to provide an alternating current signal to the pair of electrodes and including the primary winding of the transformer configured and arranged as a resonant inductor; and
wherein the pair of electrodes are configured and arranged to connect the fluorescent lamp in series between the secondary winding of the transformer and the primary winding of the transformer.

22. The apparatus of claim 21, further comprising a plurality of transistors included in the resonant tank circuit.

23. The apparatus of claim 21, further comprising a charge pump configured and arranged to drive the resonant tank circuit with a DC voltage.

24. The apparatus of claim 21, further comprising:
a lamp having a first filament connected to a first one of the pair of electrodes and a second filament connected to a second one of the pair of electrodes; and
wherein, the transformer includes second and third secondary windings each connected in series with a respective one of the first and second filaments of the lamp.

25. The apparatus of claim 21, further comprising a resistor, the resistor connected in series between the secondary winding and a ground voltage, and wherein the secondary winding is configured for end of life detection of the fluorescent lamp.

26. The apparatus of claim 21, wherein the resonant tank circuit includes: a capacitive value defined by a capacitive circuit, the capacitive circuit being connected with the primary winding of the transformer in an LC arrangement.

27. The apparatus of claim 26, wherein:
the resonant tank circuit further includes first and second outputs configured and arranged to provide the alternating current signal to the pair of electrodes; and
the capacitive circuit has a first end directly connected to the primary winding and the first output of the resonant tank circuit, and has a second end directly connected to the second output of the resonant tank circuit.

28. The apparatus of claim 27, wherein the second output of the resonant tank circuit is connected to a ground voltage.

29. The apparatus of claim 21, wherein the secondary winding is configured and arranged to provide a voltage that reduces a voltage of the alternating signal provided by the resonant tank circuit

30. An apparatus, comprising:
a transformer having a primary winding and a secondary winding;
a first circuit configured and arranged to convert a first AC voltage to a DC voltage;
a second circuit configured and arranged to convert the DC voltage to a second AC voltage, the second circuit including a resonant tank circuit having first and second output nodes and including the primary winding of the transformer;
wherein the secondary winding of the transformer is connected in series with first and second terminals of the apparatus between the first and second output nodes, the first and second terminals being configured and arranged for connecting a load to the second AC voltage
wherein, the secondary winding is oriented in a direction such that voltage induced across the secondary winding by electromagnetic flux of the primary winding reduces voltage across the first and second output nodes.

31. The apparatus of claim 30, further comprising a fluorescent lamp connected as the load in series between the first and second terminals of the apparatus.

32. The apparatus of claim 31, therein the apparatus is a compact fluorescent lamp.

33. The compact fluorescent lamp of claim 32, wherein:
the primary winding of the transformer is connected to the first output node; and
the secondary winding of the transformer is connected between the first output node and the fluorescent lamp.

34. The compact fluorescent lamp of claim 32, wherein:
the primary winding of the transformer is connected to the first output node; and
the secondary winding of the transformer is connected between the second output node and the lamp.

35. The compact fluorescent lamp of claim 32, wherein the second circuit is a resonant inverter circuit having:
the resonant tank circuit; and
a switch network coupled to receive the DC voltage from the first circuit and output and a second DC voltage to the resonant tank circuit.

36. The compact fluorescent lamp of claim 32, wherein the winding ratio of the primary winding of the transformer and the secondary winding is configured such that a voltage between a range of 20-30 volts is induced across the secondary winding during operation.

37. The compact fluorescent lamp of claim 32, wherein:
the fluorescent bulb includes a first burner filament at a first end and a second burner filament at a second end; and
the transformer includes a second secondary winding connected in series with the first burner filament, and a third secondary winding connected in series with the second burner filament.

38. The compact fluorescent lamp of claim 35, wherein:
the primary winding of the transformer is connected to the first output node;
the secondary winding of the transformer is connected between the second output node and the lamp; and
the resonant tank circuit includes a capacitive value defined by a capacitive circuit, the capacitive circuit being connected to the primary winding of the transformer in a resonant tank configuration, a first end of the capacitor being connected to the first output node, and a second end of the capacitor being connected to the second output node.

39. The compact fluorescent lamp of claim 36, wherein:
the primary winding of the transformer is connected to the first output node; and
the resonant tank circuit includes a capacitive value defined by a capacitive circuit, the capacitive circuit being connected to the primary winding of the transformer in a resonant tank configuration, a first end of the capacitor being connected to the first output node, and a second end of the capacitor being connected to the second output node, the capacitive value being set as a factor of the voltage induced across the secondary winding during operation.

40. The compact fluorescent lamp of claim 37, wherein the resonant tank circuit and a switch network are configured and arranged such that at least 100 volts rms is provided between the first burner filament and the second burner filament during operation, a current through the primary winding of the transformer being limited to not more than 300 mA during operation.

41. A method of supplying current to a fluorescent lamp, comprising:
generating a first DC voltage from a first AC voltage;
converting the first DC voltage to a second DC voltage using a switching network;
using a resonant tank circuit including a primary winding of a transformer configured and arranged as a resonant inductor, generating a second AC voltage from the second DC voltage across first and second output nodes of the resonant tank circuit; and
generating a voltage across a secondary winding of the transformer, the voltage across the secondary winding being oriented in a direction that reduces voltage across the first and second output nodes.
